(19) United States
(12) Patent Application Publication
(10) Pub. No.: US 2026/0061656 A1
(43) Pub. Date: Mar. 5, 2026

(54) MACHINING TOOL HAZARD MITIGATION SYSTEM

(71) Applicant: JPW Industries Inc., LaVergne, TN (US)

(72) Inventor: Charles Weber, Onalaska, WI (US)

(21) Appl. No.: 19/319,306

(22) Filed: Sep. 4, 2025

Related U.S. Application Data
(60) Provisional application No. 63/690,630, filed on Sep. 4, 2024.

(51) Int. Cl. B27G 19/02; F16P 3/14

(52) U.S. Cl. CPC B27G 19/022; F16P 3/14

(57) ABSTRACT

A machining tool is disclosed having an integrated hazard detection and mitigation system to protect an operator from accidental contact with a working element such as a blade or bit. The tool includes a hazard detection system configured to track the position or movement of a human body part relative to the working element in horizontal and vertical directions. A controller processes sensor outputs to identify hazardous conditions and, when detected, activates a hazard mitigation system. The hazard mitigation system employs a scissor linkage assembly and a retraction mechanism operable to rapidly move the working element from a deployed position above a work surface to a retracted position below the work surface. In certain embodiments, the retraction mechanism includes a spring biasing the working element downward and a latch, such as an electromagnet or mechanical latch assembly, that selectively restrains the spring until release is triggered.

### CROSS-REFERENCES TO RELATED APPLICATIONS

This application claims priority to U.S. Provisional Patent Application Ser. No. 63/690,630 filed Sep. 4, 2024, the entirety of which is incorporated by reference herein.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The present disclosure relates generally to machining tools. More particularly, the present disclosure pertains to protective systems and methods for mitigating hazardous involving a human object relative to a hazardous element of the machining tool.

### 2. Description of the Prior Art

A number of different machining tools exist to facilitate forming a work piece into a desired shape. These machining tools present a safety concern because the working element of these machining tools is typically very sharp and moves at a high rate of speed. Accordingly, severe injury such as severed digits and deep lacerations can occur if an operator contacts the working element of the machining tool. A number of different safety systems have been developed for machining tools in response to the dangers inherent in an exposed working element moving at high speed. Such safety systems are operable to trigger a reaction or stoppage device upon detecting or sensing the proximity or contact of some appendage of an operator with the working element of the machining tool. Current reaction or stoppage devices for machining tools suffer from issues such as complexity, user errors, complex maintenance procedures, calibration, slow speed of activation, and durability.

### BRIEF SUMMARY

In view of at least some of the above-referenced problems associated with machining tools, an exemplary object of the present disclosure may be to provide a new machining tool with hazard detection system and a hazard mitigation system. The hazard detection and mitigation systems are proposed to protect a body part of an operator from accidentally coming into contact with a running blade or working element of the machining tool, which can result in serious injury. The proposed solution may feature a non-contact hazard detection mechanism that triggers a safety response by stopping and/or retracting the blade. The key advantage of this solution is that generates a safety response before the operator's hand makes contact with the active working element by at least retracting the working element beneath the work surface using a scissor linkage assembly and retraction mechanism. The total response time, including hazard detection and mitigation, may be less than 100 milliseconds.

In a particular embodiment, an exemplary machining tool as disclosed herein may include a working element, a hazard mitigation system, a hazard detection system, and a controller operatively connected to the hazard mitigation system and the hazard detection system. The working element may be positioned adjacent to a work surface of the machining tool. The hazard mitigation system may be operatively connected to the working element. The hazard detection system may be positioned proximate to the working element. The hazard detection system may include at least one sensor configured to track a position of a human body part relative to the working element in at least one horizontal direction and a vertical direction. The at least one horizontal direction may be parallel to the work surface and the vertical direction perpendicular to the work surface. The controller may be configured to determine a position and/or movement of the human body part relative to the working element based on outputs from the hazard detection system, identify a hazardous situation based on the determined position and/or movement of the human body part relative to the working element, and activate the hazard mitigation system in response to the identified hazardous situation.

### BRIEF DESCRIPTION OF THE SEVERAL VIEWS OF THE DRAWINGS

FIG. 1 is a block diagram of a machining tool in accordance with the present disclosure.

FIG. 2 is a side elevation view of a first embodiment of a machining tool in a raised position in accordance with the present disclosure.

FIG. 3 is a side elevation view of the machining tool of FIG. 2 in a lowered position in accordance with the present disclosure.

FIG. 4 is a perspective view of a retraction mechanism of the machining tool of FIG. 2 in a retracted position in accordance with the present disclosure.

FIG. 5 is a perspective view of the retraction mechanism of the machining tool of FIG. 2 in an extended position in accordance with the present disclosure.

FIG. 6 is a side elevation view of a second embodiment of a machining tool in accordance with the present disclosure.

FIG. 7 is a partial cross-sectional side elevation view of a retraction mechanism of the machining tool of FIG. 6 in accordance with the present disclosure.

FIG. 8 is a partial cross-sectional side elevation view of an embodiment of a retraction mechanism for a machining tool in a push condition in accordance with the present disclosure.

FIG. 9 is a partial cross-sectional side elevation view of the retraction mechanism of FIG. 8 a pull condition in accordance with the present disclosure.

FIG. 10 is an enlarged upper perspective view of the retraction mechanism of FIG. 8 in accordance with the present disclosure.

FIG. 11 is an enlarged lower perspective view of the retraction mechanism of FIG. 8 in accordance with the present disclosure

FIG. 12 is a side elevation view of a third embodiment of a machining tool in a raised position in accordance with the present disclosure.

FIG. 13 is a side elevation view of a third embodiment of a machining tool in a lowered position in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

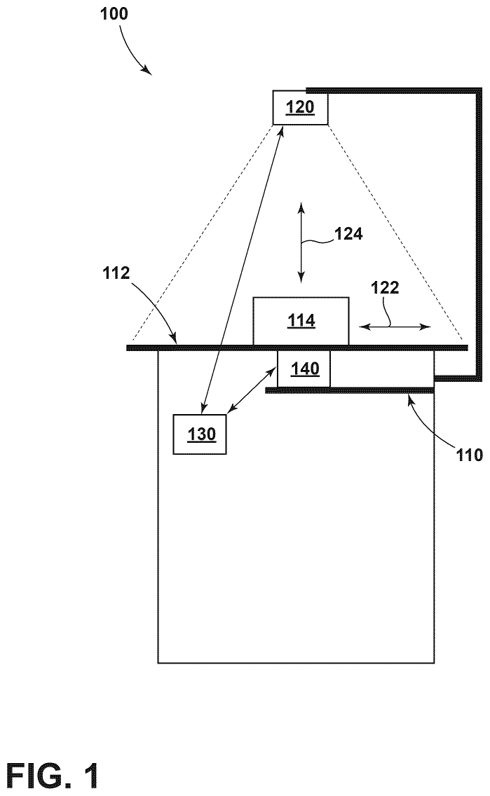

Referring to FIGS. 1-3 and 6, a machining tool 100 is provided. The machining tool 100 may include a frame 110, a work surface 112 positioned above the frame 110, and a working element 114 supported by the frame 110 and positioned adjacent or proximate to a work surface 112 of the machining tool 100. In certain optional and nonlimiting embodiments, the machining tool 100 may, for example, be a table saw, a router table, a planar, a jointer, a rip saw, a panel saw, or the like. As such, the working element 114 may be a saw blade, planar blade, a router bit, or some other sharp implement configured to interact with a work piece, such as wood, metal, or the like.

The machining tool 100 may further include a hazard detection system 120 positioned proximate to the working element 114. The hazard detection system 120 may be configured to track a position of a human body part relative to the working element 114. As illustrated in FIG. 1, the hazard detection system 120 may be configured to detect a hazardous condition between the at least human body part and the working element 114. In some embodiments, the hazard detection system 120 can be operable to track or monitor a position of at least one human body part relative to the working element 114 to determine when the at least one human body part is in a dangerous position. In some embodiments, the hazard detection system 120 may be operable to track or monitor the position of the at least one human body part in at least one first direction and/or at least one second direction. The at least one first direction 122 may be parallel to the work surface 112 and the at least one second direction 124 may be perpendicular to the work surface 112. The human body part may, for example, be a hand, arm, or some other appendage that may accidentally contact the working element 114. In other embodiments, other hazard detection systems can be implemented, including systems operable to detect contact between the working element 114 and the human body part, or generally detect when the human body part is in a dangerous condition with respect to the working element 114.

The machining tool 100 may further include a hazard mitigation system 140 configured to interact with the working element 114 to mitigate any safety risk when a dangerous condition is detected. In some embodiments, the hazard mitigation system can be operable to alert an operator of the machining tool 100 of a hazardous situation. The hazard mitigation system 140 may include one or more of an auditory alarm or a visual alarm. In other optional embodiments, the hazard mitigation system 140 can be operable to remove the dangerous condition, when detected, for example, using a reactionary mechanical/electrical/electromechanical mechanism (according to the various systems and methods described herein) operatively coupled to the working element 114 for stopping the working element 114 or retracting the working element 114 beneath or away from the work surface 112 or away from the operator. The hazard detection system 120, while illustrated directly above the working element 114, may alternatively be positioned elsewhere relative to the work surface 112 and/or working element 114.

The machining tool 100 may further include a controller 130 operatively connected to the hazard detection system 120 and the hazard mitigation system 140. The controller 130 may be configured to determine a position and/or movement of the human body part relative to the working element 114 based on outputs from the hazard detection system 120. The controller 130 may further be configured to identify a hazardous situation based on the determined position and/or movement of the human body part relative to the working element 114. The controller 130 may further be configured to activate the hazard mitigation system 140 in response to the identified hazardous situation. The hazardous situation may be based at least in part on the determined position of the human body part being within a predetermined distance from the working element 114. In certain optional embodiments, the predetermined distance may be less than 100 mm, 90 mm, 80 mm, 70 mm, 65 mm, 60 mm, 55 mm, 50 mm, 45 mm, 40 mm, 35 mm, 30 mm, 25 mm, 20 mm, 15 mm, 10 mm, 9 mm, 8 mm, 7 mm, 6 mm, 5 mm, 4 mm, 3 mm, 2 mm, or 1 mm. In certain optional embodiments, the predetermined distance may be greater in front of the working element 114 than beside the working element 114. In other optional embodiments, the hazardous situation may be based at least in part on the determined position of the human body part being within a predefined zone surrounding the working element 114. In some embodiments the zone can extend further in front of the working element 114 as opposed to beside the working element 114, for instance in the case of a circular saw blade where the teeth at the circumferential edges of the saw blade are more dangerous than a side of the saw blade.

The hazardous situation may, in addition to or alternatively, be based at least in part on a determined movement (e.g., direction and rate of speed or velocity) of the human body part relative to the working element 114. In certain optional embodiments, a hazardous situation based on the determined movement may only be realized when the human body part is within the predetermined distance, some other intermediate threshold distance, or the predefined zone. In other optional embodiments, the hazardous situation based on the determined movement may be independent of whether the human body part is within the predetermined distance or the predefined zone.

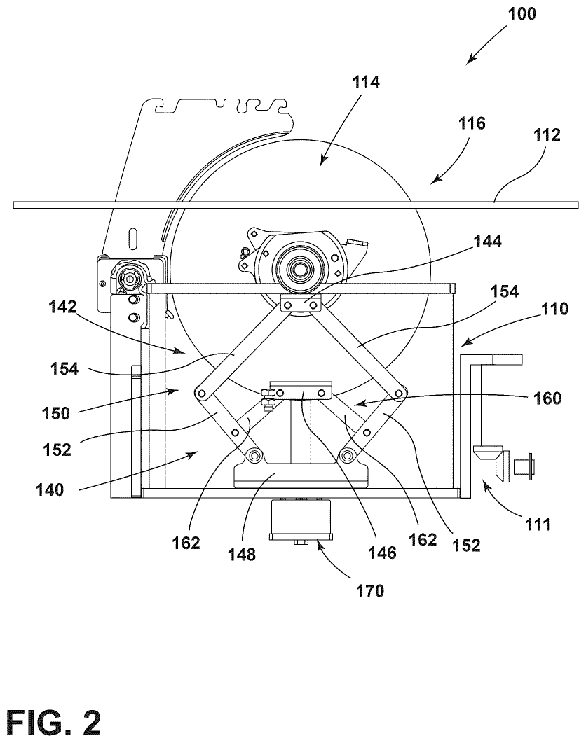

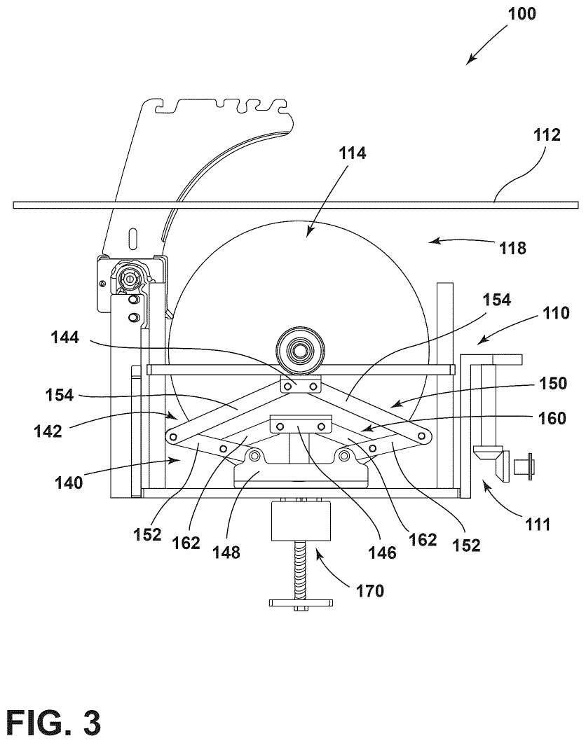

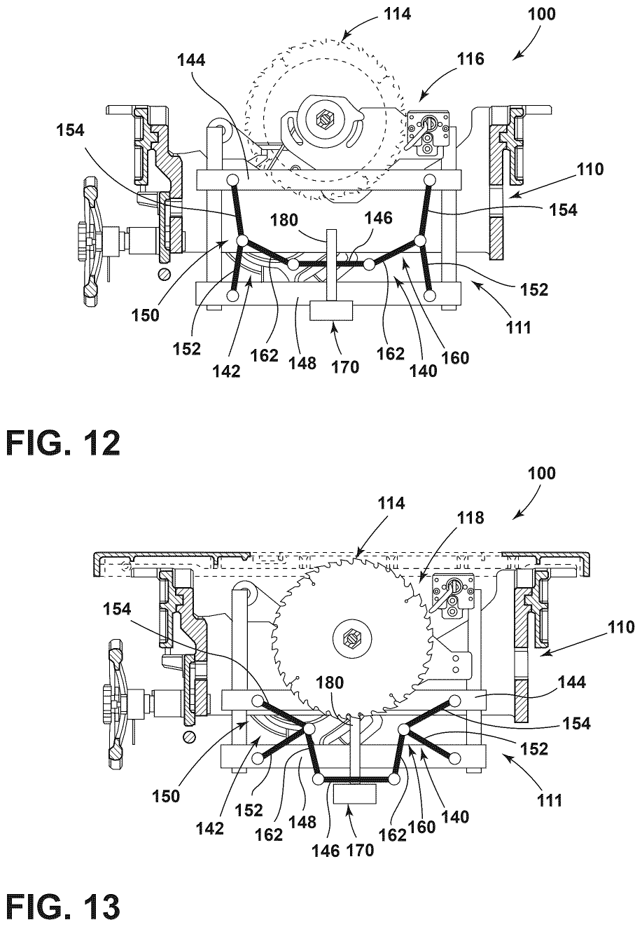

As illustrated in FIGS. 1-3, 6, and 12-13, the hazard mitigation system 140 may include a scissor linkage assembly 142 and a retraction mechanism 170. The scissor linkage assembly 142 may include at least one support linkage 150 and at least one retraction linkage 160. The at least one support linkage 150 may be configured to support the working element 114 and may be coupled between the working element 114 and the frame 110. The retraction mechanism 170 may be configured to engage the at least one retraction linkage 160 to move the at least one support linkage 150 and thus the working element 114 from a deployed position 116 to a retracted position 118 when the hazardous situation is detected. As illustrated in FIG. 2, the working element 114 may be positioned at least partially above the work surface 112 in the deployed position 116. As illustrated in FIG. 3, the working element 114 may be positioned beneath the work surface 112 in the retracted position 118.

The scissor linkage assembly 142 may further include an upper saddle 144 coupled to the working element 114 and a lower saddle 146 coupled to the retraction mechanism 170. The lower saddle 146 may be positioned between the frame 110 and the upper saddle 144. The upper and lower saddles 144, 146 may provide pivotal connection point(s) for the at least one support linkage 150 and the at least one retraction linkage 160.

The support linkage 150 may include a lower pair of support linkages 152 coupled to the frame 110 and an upper pair of support linkages 154 coupled between the lower pair of support linkages 152 and the upper saddle 144, with corresponding combinations of lower support linkages 152 and upper support linkages 154 being pivotally connected together to create a scissoring action for the scissor linkage assembly 142. The retraction linkage 160 may include a pair of retraction linkages 162 coupled between the lower pair of support linkages 152 and the lower saddle 146. In certain optional embodiments, the support linkage 150 may include a single combination of lower and upper support linkages 152 and 154 pivotally connected together and the retraction linkage 160 may comprise a single retraction linkage 160 rather than pairs as previously described and shown. Pairs of support linkages 150 and retraction linkages 160 on either side of the saddles 144 and 146, working element 114, and retraction mechanism 170 can generally help provide balance during the retraction step and help minimize stress on the components of the hazard mitigation system 140 and the machining tool 100.

In some embodiments, the hazard mitigation system 140 may further include a base plate 148 coupled between the frame 110 and the support linkage 150. The base plate 148 may provide pivotal connection point(s) for the support linkage 150. In certain optional embodiments, the pair of retraction linkages 162 may be coupled to the lower pair of support linkages 152 closer to the base plate 148 than to the upper pair of support linkages 154. In other optional embodiments, the pair of retraction linkages 162 may be coupled to the lower pair of support linkages 152 closer to the upper pair of support linkages 154 than to the base plate 148.

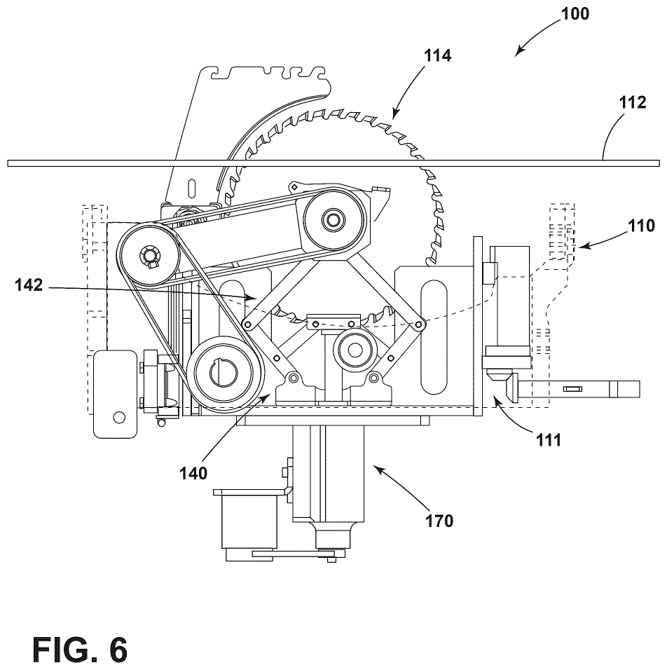

In certain optional embodiments, the frame 110 may be a base of the entire machining tool 100. In other optional embodiments, the frame 110 may comprise a carriage assembly 111 for adjusting a position of the working element 114 relative to the work surface 112. The carriage assembly 111 may enable a height of the working element 114 protruding from the work surface 112 to be adjustable or an angle of the working element 114 relative to the work surface 112 to be adjustable. As illustrated in FIG. 6, the machining tool 100 may further include a motor configured to drive the working element 114. The motor may be coupled to the carriage assembly 111 and move with the carriage assembly 111. Likewise, the hazard mitigation system 140 may be coupled to the carriage assembly 111 and move with the carriage assembly 111.

The retraction mechanism 170 may include a rod 180 coupled to the lower saddle 146. The rod 180 may extend below the base plate 148. The retraction mechanism 170 may include a spring 172 configured to bias the working element 114 towards the retracted position 118 via a spring force 174. The spring 172 may surround the rod 180. The retraction mechanism 170 may further include a latch/stop 176 (e.g., mechanical, electromechanical, electrical, or the like) configured to selectively prevent the spring force 174 for moving the working element 114 from the deployed position 116 to the retracted position 118 when the hazardous situation is detected. As such, the spring 172 may be compressed when the working element 114 is in the deployed position 116 and the spring force 174 may be directed downward or away from the work surface 112.

As illustrated in FIGS. 2-7, in some embodiments, the latch 176 may comprise an electromagnet configured to interact with a permanent magnet 178 coupled to the rod 180, which when engaged may hold the working element 114 in the deployed position 116. In other optional embodiments, the latch 176 may be a mechanical latch which may be disengaged using an actuator, including but limited to a solenoid or other similar electromechanical actuator. The actuator may be configured to selectively release the latch 176 for enabling the spring force 174 to act on the working element 114 for moving the working element 114 from the deployed position 116 to the retracted position 118 when the hazardous situation is detected.

In the case of the latch 176 being an electromagnet, the electromagnet may develop strong holding force with the permanent magnet 178 in the de-energized state with no excitation power. An electrical excitation in the reverse direction (opposing the field due to permanent magnet) will actuate the retraction mechanism 170 to release to allow the spring force 174 to act on the rod 180.

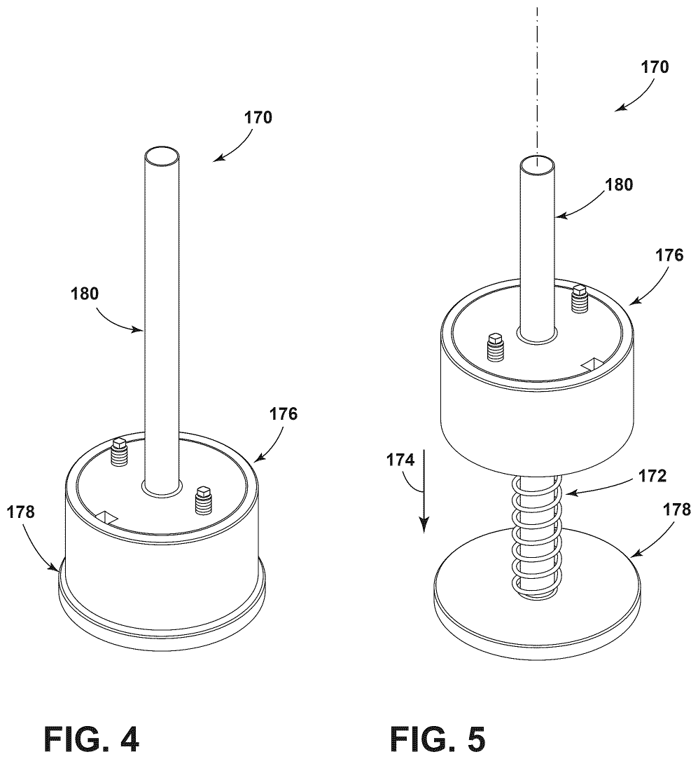

The electromagnet of FIGS. 4-5 in some embodiments may include several key components to ensure its proper functioning. The electromagnet may include an ejector pin, an armature plate, a custom winding, and a permanent magnet. The ejector pin is a pre-loaded spring pin designed to overcome residual magnetism, which helps in reducing the holding force by approximately 10%. This component ensures that the electromagnet can release effectively when required. The armature plate, made of a ferromagnetic material and typically nickel-plated, serves as the magnetic counterpart to the electromagnets, creating the necessary magnetic interaction for the device's operation. Custom winding is used to tailor the electromagnet's performance to specific requirements, providing the necessary magnetic field strength and efficiency. Finally, the permanent magnet plays a crucial role in the electrical release mechanism, allowing the electromagnet to switch states as needed. Together, these components create a reliable and efficient electromagnet system.

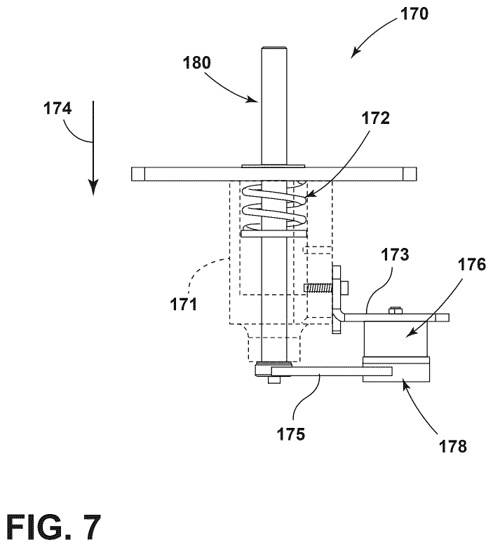

As illustrated in FIG. 7, another embodiment of the latch 176 of the retraction mechanism 170 as an electromagnet is illustrated. In addition to the spring 172, the latch 176, and the permanent magnet 178, the retraction mechanism 170 may further include a spring housing 171, an angle plate 173, and an armature plate 175. The electromagnet may be offset from the rod 180 using the armature plate which may include the permanent magnet 178 coupled thereto. The angle plate may be coupled to the spring housing and the electromagnet may be coupled to the angle plate to align with the permanent magnet of the armature plate. The spring 172 may be positioned within the spring housing surrounding the rod 180. In some embodiments, no permanent magnet is used as the retention force, but the electromagnetic itself can provide said retention force, and upon detection of the hazardous condition, the electromagnet can simply be switched off to allow the spring force to move the working element 114 to the retracted position.

In certain optional embodiments, the retraction mechanism 170 may include a lifting mechanism or a lifting mechanism may be included separate from the retraction mechanism 170 for resetting the working element 114 from the retracted position 118 into the deployed position 116. For example, a hydraulic jack may be implemented to reset the working element 114 from the retracted position 118 into the deployed position 116. In other optional embodiments, the working element 114 may be manually reset into the deployed position 116 by engaging the retraction mechanism 170.

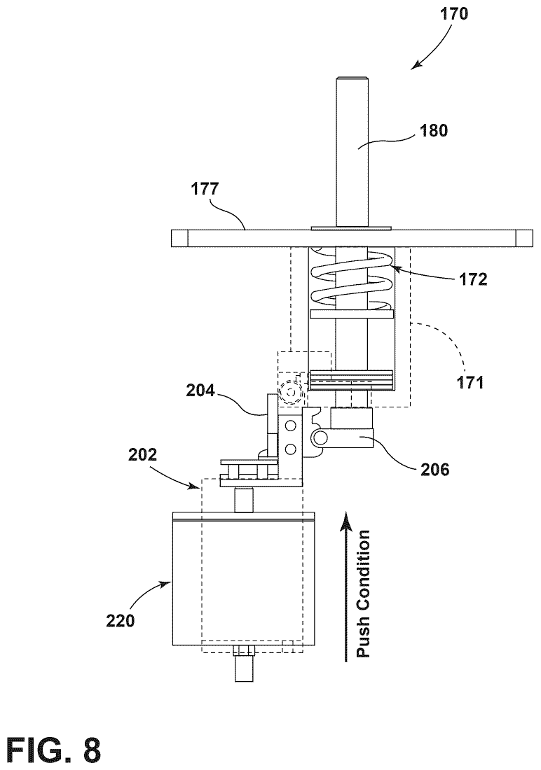

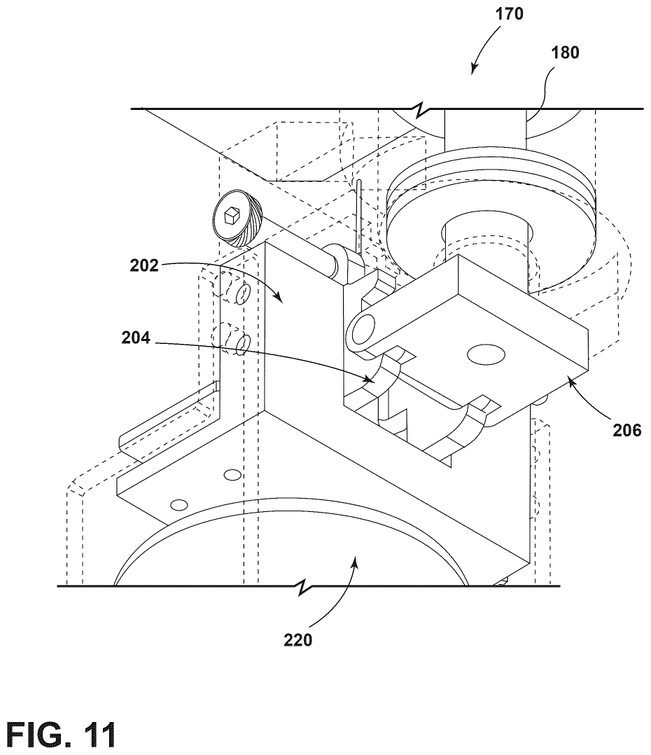

As illustrated in FIGS. 8-11, another embodiment of the retraction mechanism 170 is shown. The retraction mechanism 170 of FIGS. 8-11 is similar to the retraction mechanism 170 of FIG. 7, however, the latch 176 of FIGS. 8-11 is a mechanical latch assembly 200, rather than an electromagnet. In addition to the spring 172, the spring housing 171, the mounting plate 177, and the rod 180, the mechanical latch assembly 200 includes a solenoid mounting bracket 202 coupled to a lower portion of the spring housing. The solenoid mounting bracket 202 may support a latch lever 204. The latch lever 204 may be biased towards and configured to engage a holding plate 206 coupled to a lower end of the rod 180 for maintaining the working element 114 in the deployed position 116. The latch lever 204 may be coupled to the solenoid mounting bracket using a pin 208 and may be biased towards the holding plate 206 using a torsion spring 210.

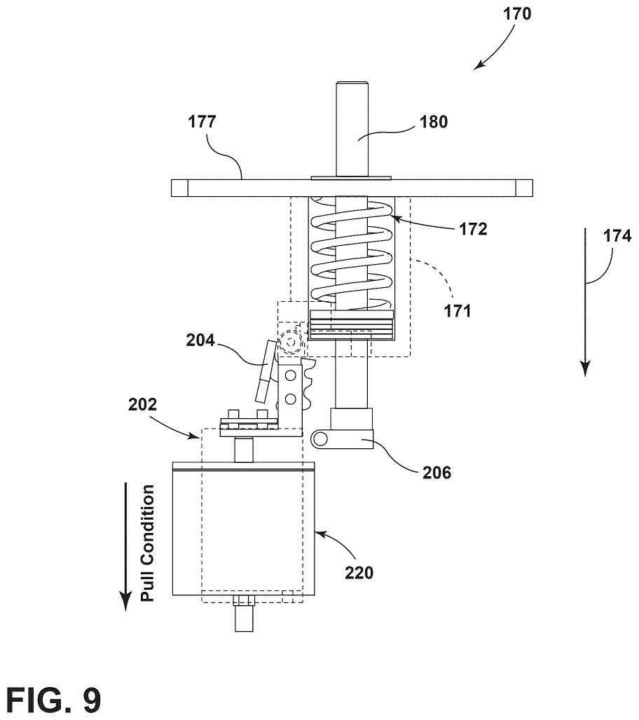

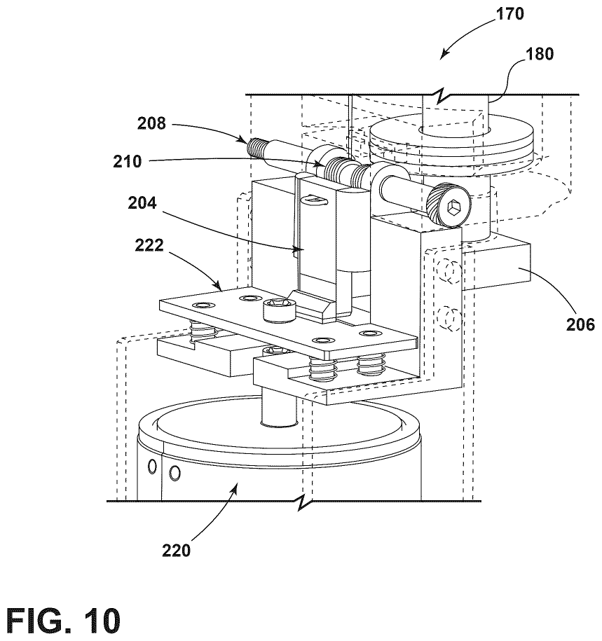

The mechanical latch assembly 200 may further include a solenoid 220 (e.g., a push/pull type solenoid) configured to raise and lower a latch plate 222. The latch plate 222 may be slidably coupled to the solenoid mounting bracket 202 using a plurality of guide pins and compression springs for holding the latch plate 222 in a raised position for engaging the latch lever 204 until the solenoid 220 acts upon and lowers the latch plate 222. The solenoid 220 may be coupled to the latch plate 222 using a solenoid shaft screw, as illustrated in FIG. 10. As illustrated in FIG. 9, when the solenoid 220 lowers the latch plate 222 the latch lever 204 is released, which allows the spring force 174 to act upon the rod 180 for moving the working element 114 from the deployed position 116 to the retracted position 118, via the rod's interaction with the scissor linkage assembly 142. The solenoid 220 may include a push condition, as illustrated in FIG. 8, which corresponds to the deployed position 116 of the working element 114. The solenoid 220 may further include a pull condition, as illustrated in FIG. 9, which corresponds to the retracted position 118 of the working element 114. In certain optional embodiments, the push condition of the solenoid 220 may occur when a positive polarity voltage is provided to the solenoid 220, and the pull condition of the solenoid 220 may occur when a negative polarity voltage is provided to the solenoid 220. In other optional embodiments, the push condition of the solenoid 220 may occur when a negative polarity voltage is provided to the solenoid 220, and the pull condition of the solenoid 220 may occur when a positive polarity voltage is provided to the solenoid 220. In further optional embodiments, the push condition of the solenoid 220 may occur when a voltage is applied to the solenoid 220, and the pull condition of the solenoid 220 may occur when no voltage is applied to the solenoid 220. In still further optional embodiment, the push condition of the solenoid 220 may occur when no voltage is applied to the solenoid 220, and the pull condition of the solenoid 220 may occur when a voltage is applied to the solenoid 220.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on. ” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A machining tool comprising:
a frame;
a work surface positioned above to the frame;
a working element supported by the frame and positioned adjacent to the work surface;
a hazard mitigation system operatively connected to the working element, the hazard mitigation system including a scissor linkage assembly and a retraction mechanism, the scissor linkage assembly having at least one support linkage and at least one retraction linkage, the at least one support linkage coupled between the working element and the frame, and the at least one retraction linkage coupled between the retraction mechanism and the at least one support linkage, the retraction mechanism configured to engage the at least one retraction linkage for moving the working element via the at least one support linkage from a deployed position to a retracted position;
a hazard detection system operable to track a position of a human body part relative to the working element; and
a controller operatively connected to the hazard mitigation system and the hazard detection system, the controller configured to:
identify a hazardous situation based on outputs from the hazard detection system; and
activate the hazard mitigation system in response to the identified hazardous situation.

2. The machining tool of claim 1, wherein:
the working element is positioned at least partially above the work surface in the deployed position; and
the working element is positioned beneath the work surface in the retracted position.

3. The machining tool of claim 1, wherein the scissor linkage assembly further comprises:
an upper saddle coupled to the working element; and
a lower saddle coupled to the retraction mechanism, the at least one support linkage and the at least one retraction linkage being pivotally connected between the upper and lower saddles.

4. The machining tool of claim 3, wherein:
the retraction mechanism comprises a rod coupled to the lower saddle, the rod extending below a base plate of the frame.

5. The machining tool of claim 4, wherein:
the retraction mechanism further comprises a spring surrounding the rod, the spring configured to bias the working element toward the retracted position.

6. The machining tool of claim 5, wherein:
the retraction mechanism further comprises a latch configured to selectively restrain the spring, the latch operable to enable movement of the spring in response to the hazardous situation.

7. The machining tool of claim 6, wherein:
the latch comprises an electromagnet configured to interact with a permanent magnet coupled to the rod.

8. The machining tool of claim 7, wherein:
the electromagnet is configured to release the rod when energized to oppose the magnetic field of the permanent magnet.

9. The machining tool of claim 6, wherein the latch comprises a mechanical latch assembly including:
a latch lever configured to engage a holding plate of the rod; and
a solenoid configured to disengage the latch lever to permit the spring to move the working element to the retracted position.

10. The machining tool of claim 9, wherein:
the solenoid is operable in a push condition corresponding to the deployed position of the working element and a pull condition corresponding to the retracted position of the working element.

11. The machining tool of claim 1, wherein:
the at least one support linkage comprises a lower pair of support linkages pivotally connected to the frame and an upper pair of support linkages pivotally connected between the lower pair of support linkages and the working element.

12. The machining tool of claim 11, wherein:
the at least one retraction linkage comprises a pair of retraction linkages coupled between the lower pair of support linkages and the retraction mechanism.

13. The machining tool of claim 1, wherein:
the at least one retraction linkage comprises a pair of retraction linkages coupled between the at least one support linkage and the retraction mechanism.

14. The machining tool of claim 1, further comprising:
a base plate coupled between the frame and the at least one support linkage, the base plate providing a pivotal connection point for the at least one support linkage.

15. The machining tool of claim 1, wherein:
the frame comprises a carriage assembly configured to adjust a height or angle of the working element relative to the work surface.

16. A hazard mitigation system for a machining tool having a working element, the hazard mitigation system comprising:
a scissor linkage assembly configured to support the working element of the machining tool, the scissor linkage assembly including at least one support linkage and at least one retraction linkage; and
a retraction mechanism coupled to the at least one retraction linkage, the retraction mechanism configured to move the working element via the at least one support linkage between a deployed position and a retracted position in response to activation,
wherein the retraction mechanism includes a biasing member configured to urge the working element toward the retracted position and a latch configured to selectively restrain the biasing member until activation of the hazard mitigation system.

17. The hazard mitigation system of claim 16, wherein:
the latch comprises an electromagnet configured to hold the working element in the deployed position and to release the working element when energized.

18. The hazard mitigation system of claim 16, wherein:
the latch comprises a mechanical latch assembly including a latch lever engageable with a holding plate of a rod coupled to the working element via the scissor linkage assembly, and an actuator configured to disengage the latch lever.

19. The hazard mitigation system of claim 16, wherein:
the biasing member comprises a spring surrounding a rod of the retraction mechanism, the spring configured to apply a force directing the working element away from a work surface of the machining tool.

20. The hazard mitigation system of claim 16, further comprising:
an upper saddle configured to couple to the working element and a lower saddle configured to couple to the retraction mechanism, the at least one support linkage and the at least one retraction linkage being pivotally coupled at least in part between the upper and lower saddles.
